(19) United States
(12) Patent Application Publication
(10) Pub. No.: US 2016/0328474 A1
(43) Pub. Date: Nov. 10, 2016

(54) DATA RECORDING AND DATA RECORDING APPARATUS

(71) Applicants: Jun SHI, Beijing (CN); Qing YANG, Beijing (CN)

(72) Inventors: Jun SHI, Beijing (CN); Qing YANG, Beijing (CN)

(21) Appl. No.: 14/771,673

(22) PCT Filed: May 8, 2015
(86) PCT No.: PCT/IB2015/053398

§ 371 Date: Mar. 16, 2016

(51) Int. Cl. G06F 17/30; G06K 9/00; H04L 29/08

(52) U.S. Cl. CPC G06F 17/30784; H04L 67/10; H04L 67/22; G06F 17/30867; G06K 9/00684; G06K 9/00677

(57) ABSTRACT

Embodiments of the present disclosure provide a data recording method, a data recording apparatus and electronic equipment. The data recording apparatus includes: a first acquiring unit configured to acquire information on a group of people; an analyzing unit configured to analyze the information on a group of people acquired by the acquiring unit, so as to determine whether there exists a hot topic; and a recording unit configured to perform a recording action when an analysis result of the analyzing unit is that there exists a hot topic. According to this application, the data recording apparatus performs the recording action when there exists a hot topic in the group of people, thereby obtaining video and audio data attracting interests of users more easily.

### CROSS-REFERENCE TO RELATED APPLICATION AND PRIORITY CLAIM

This application claims the benefit of Chinese Patent Application Serial No. 201410645607.5, filed Nov. 12, 2014, the entire disclosure of which is hereby incorporated by reference.

### TECHNICAL FIELD

The present disclosure relates to the field of data recording, and in particular to a data recording method, a data recording apparatus and electronic equipment.

### BACKGROUND ART

As technologies and sciences develop, there appears a portable data recording apparatus, which is wearable by a user and is capable of performing actions, such as taking photos, e.g., recording photos digitally, capturing videos and recording audios, so as to record events that happened around the user. For example, the data recording apparatus may be a lifelog.

A conventional lifelog camera is capable of taking photos based on a time, such as taking photos based on an interval of 30 seconds, which may take nearly 3000 photos in a day. On the one hand, a number of these photos may not be of interest to the user; and on the other hand, a scenario that is of interest to the user may be neglected or not taken. Therefore, an improper time of taking not only results in waste of storage space of the camera and an amount of power of the battery, but also results in that the user cannot obtain photos in an expected scenario, thereby lowering use experiences of the user.

It should be noted that the above description of the background art is merely provided for clear and complete explanation of the present disclosure and for easy understanding by those skilled in the art. And it should not be understood that the above technical solution is known to those skilled in the art as it is described in the background art of the present disclosure.

### SUMMARY

It was found by the inventors of this application that thanks to continuous development of mobile Internet technologies and social applications, people are able to record lives, experiences, etc. via mobile terminals, and to share with friends, colleagues or families via social network service platforms or software, such as Twitter, Facebook, What's App, Wechat or Line, etc. Some of the shared video and audio data may be further commented on, or even may become topics discussed in friend circles, e.g., a circle of friends, such as a group of people who are “friends” in Facebook, etc.; that is, these video and audio data are much easier to become interested contents. Therefore, a discussed topic in a social network may help people find scenarios that are worth recording. Triggering a lifelog camera in such scenarios may more easily obtain video and audio data that are interested by users.

And at the same time, crowd sourcing becomes a production organization manner and a data acquisition manner based on a mass network. In a process of crowd sourcing, a large amount of non-specific individuals or terminals participate in tasks given by a task petitioner, and feed back data, and the task petitioner makes a decision according to the acquired data.

Embodiments of the present disclosure provide a data recording method, a data recording apparatus and electronic equipment; information on a group of people in a social network or a current environment is collected and analyzed in a manner of crowd sourcing, so as to determine a popular topic to which attention is paid by the group of people, and to control a time of data recording of the data recording apparatus, such as a lifelog camera, according to the popular topic, thereby more easily obtaining video and audio data that are interested by users.

According to a first aspect of the embodiments of the present disclosure, there is provided a data recording apparatus, including:

a first acquiring unit configured to acquire information on a group of people;

an analyzing unit configured to analyze the information on a group of people acquired by the acquiring unit, so as to determine whether there exists a hot topic; and

a recording unit configured to perform a recording action when an analysis result of the analyzing unit is that there exists a hot topic.

According to a second aspect of the embodiments of the present disclosure,

the first acquiring unit acquires information on an interested topic of a group of people from a social network and takes it as the information on a group of people.

According to a third aspect of the embodiments of the present disclosure,

the group of people is all groups of people or a part of groups of people in the social network.

According to a fourth aspect of the embodiments of the present disclosure,

the first acquiring unit acquires physiological parameters of the group of people from a current environment and takes it as the information on a group of people.

According to a fifth aspect of the embodiments of the present disclosure, the data recording apparatus further includes:

a second acquiring unit configured to acquire an interested point of a user of the data recording apparatus; and

a first judging unit configured to judge whether the interested point of the user is related to the hot topic when an analysis result of the analyzing unit is that there exists a hot topic;

and the recording unit performs the recording action when it is judged by the first judging unit that the interested point of the user is related to the hot topic.

According to a sixth aspect of the embodiments of the present disclosure, the data recording apparatus further includes:

a third acquiring unit configured to acquire information on an environment where the data recording apparatus is located; and

a second judging unit configured to judge whether the information on the environment is related to the hot topic when an analysis result of the analyzing unit is that there exists a hot topic;

and the recording unit performs the recording action when it is judged by the second judging unit that the information on the environment is related to the hot topic.

According to a seventh aspect of the embodiments of the present disclosure,

the recording unit stores recorded data and the hot topic in an associated manner.

According to an eighth aspect of the embodiments of the present disclosure,

the recording unit records picture data, video data and/or audio data.

According to a ninth aspect of the embodiments of the present disclosure, there is provided a data recording method, using a data recording apparatus for recording data, the method including:

acquiring information on a group of people;

analyzing the acquired information on a group of people, so as to determine whether there exists a hot topic; and

performing a recording action when it is determined that there exists a hot topic.

According to a tenth aspect of the embodiments of the present disclosure,

information on an interested topic of a group of people is acquired from a social network and is taken as the information on a group of people.

According to an eleventh aspect of the embodiments of the present disclosure,

the group of people is all groups of people or a part of groups of people in the social network.

According to a twelfth aspect of the embodiments of the present disclosure,

physiological parameters of the group of people are acquired from a current environment and is taken as the information on a group of people.

According to a thirteenth aspect of the embodiments of the present disclosure, the data recording method further includes:

acquiring an interested point of a user of the data recording apparatus; and

judging whether the interested point of the user is related to the hot topic when it is determined that there exists a hot topic; and

performing the recording action when it is judged that the interested point of the user is related to the hot topic.

According to a fourteenth aspect of the embodiments of the present disclosure, the data recording method further includes:

acquiring information on an environment where the data recording apparatus is located;

judging whether the information on the environment is related to the hot topic when it is determined that there exists a hot topic; and

performing the recording action when it is judged that the information on the environment is related to the hot topic.

According to a fifteenth aspect of the embodiments of the present disclosure,

recorded data and the hot topic are stored in an associated manner.

According to a sixteenth aspect of the embodiments of the present disclosure,

the recording unit records picture data, video data and/or audio data.

According to a seventeenth aspect of the embodiments of the present disclosure, there is provided electronic equipment, having a data recording apparatus, the data recording apparatus is configured to:

acquire information on a group of people;

analyze the information on a group of people, so as to determine whether there exists a hot topic; and

perform a recording action when it is determined that there exists a hot topic.

Advantages of the embodiments of the present disclosure exist in that the data recording apparatus may perform the recording action when there exists a hot topic in the group of people, thereby obtaining video and audio data attracting interests of users more easily.

With reference to the following description and drawings, the particular embodiments of the present disclosure are disclosed in detail, and the principles of the present disclosure and the manners of use are indicated. It should be understood that the scope of the present disclosure is not limited thereto. The embodiments of the present disclosure contain many alternations, modifications and equivalents within the spirit and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of the present disclosure, which constitute a part of the specification and illustrate the preferred embodiments of the present disclosure, and are used for setting forth the principles of the present disclosure together with the description. It is obvious that the accompanying drawings in the following description are some embodiments of the present disclosure only, and a person of ordinary skill in the art may further obtain other drawings according to these accompanying drawings without making an inventive effort. In the drawings:

FIG. 1 is a schematic diagram of the structure of a data recording apparatus of an embodiment of this application;

FIG. 2 is a block diagram of the structure of electronic equipment of an embodiment of this application;

FIG. 3 is a schematic diagram of an interface of a friend circle of a user of an embodiment of this application;

FIG. 4 is a schematic diagram of an image signal of a surrounding environment obtained by an image sensor of the data recording apparatus of the embodiment of this application;

FIG. 5 is a schematic diagram of image data recorded by the data recording apparatus of an embodiment of this application;

FIG. 6 is another schematic diagram of image data recorded by the data recording apparatus of an embodiment of this application;

FIG. 7 is a schematic diagram of recording the recorded image data and a popular topic in an associated manner;

FIG. 8 is still another schematic diagram of image data recorded by the data recording apparatus of an embodiment of this application;

FIG. 9 is a flow chart of a mode of implementation of a data recording method of an embodiment of this application;

FIG. 10 is a flowchart of another mode of implementation of a data recording method of an embodiment of this application; and

FIG. 11 is a flowchart of still another mode of implementation of a data recording method of an embodiment of this application.

### DETAILED DESCRIPTION

Many aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

### Embodiment 1

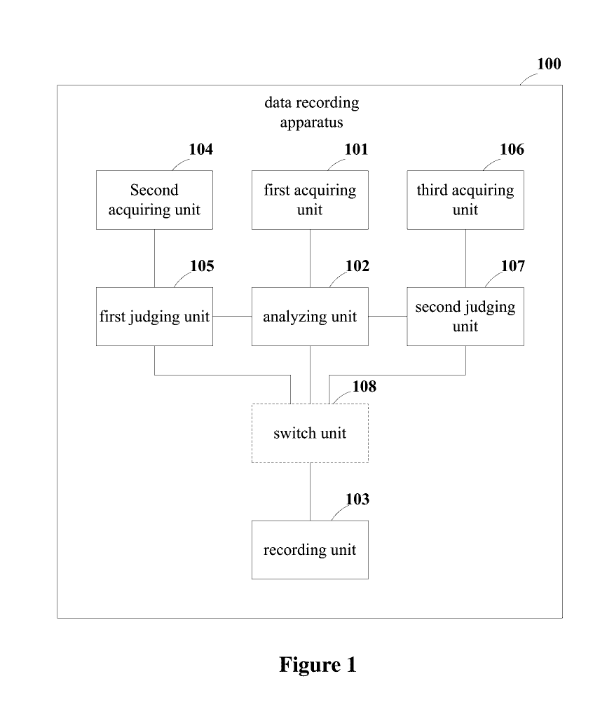

An embodiment of the present disclosure provides a data recording apparatus. FIG. 1 is a schematic diagram of the structure of the data recording apparatus. As shown in FIG. 1, the data recording apparatus 100 includes a first acquiring unit 101, an analyzing unit 102 and a recording unit 103. It will be appreciated that the term “unit” as used herein may mean and be used equivalently and interchangeably with the term “module” or the like.

The first acquiring unit 101 is configured to acquire information on a group of people; the analyzing unit 102 is configured to analyze the information on a group of people acquired by the acquiring unit, so as to determine whether there exists a hot topic; and the recording unit 103 is configured to perform a recording action when an analysis result of the analyzing unit is that there exists a hot topic. For example, a hot topic may be a topic or subject, e.g., an interested topic (described below) that is of current relevant, substantial or meaningful interest to a number of people, or all the people, in the group of people. For example, a hot topic may be a topic that is of interest to a number of people, e.g., a topic discussed by a number of people.

According to Embodiment 1 of this application, the data recording apparatus 100 may perform a recording action when there exists a hot topic in the group of people, thereby obtaining video and audio data attracting interests of users more easily.

In a mode of implementation, the first acquiring unit 101 is able to acquire information on an interested topic (e.g., also meaning herein a topic of interest or an interesting topic) of the group of people from a social network and take it as the information on a group of people. For example, the first acquiring unit 101 may collect information, such as comments, pictures, videos, and discussed topics, etc., posted by people in the social network, via social network service platforms or software, such as Twitter, Facebook, What's App, Wechat or Line, etc., and count such information, so as to extract information on an interested topic to which attention is paid by the group of people. The information on an interested topic may include, for example, an interested topic, and the number of participants, frequencies of update, and the number of messages that are left, of or about the interested topic; and, for example, the interested topic may be indexed by a keyword, a picture, or a digit, etc.

In this embodiment, the first acquiring unit 101 may acquire the information on an interested topic based on all groups of people in the social network, or may acquire the information on an interested topic based on a part of groups of people in the social network. For example, the part of groups of people may be a group of people associated with a user of the data recording apparatus 100, such as a group of people in which the user is interested, a group of people interested in the user, a group of people interested in the same things as the user, a group of people having a specific relationship with the user, such as colleagues, relatives, or friends, etc., and/or a group of people geographically close to the user, etc.

Furthermore, in this embodiment, such operations as the collection and counting of the above information and extraction of the information on an interested topic of a group of people may be performed by a server, and the first acquiring unit 101 may acquire the information on an interested topic directly from the server. It should be noted that a manner of acquiring the information on an interested topic by the first acquiring unit 101 is not limited thereto, and other manners may also be used.

In another mode of implementation, the first acquiring unit 101 may acquire physiological parameters of the group of people from a current environment and take it as the information on a group of people. The current environment may be, for example, an environment of a range, e.g., area, breadth, extent, etc., spaced apart from the data recording apparatus 100 by a certain distance. For example, in a case where the group of people in the current environment wear wearable devices, the wearable devices may detect physiological parameters of the wearers, such as a blood pressures, a pulse, a heart rate and/or a temperature, and transmit these physiological parameters outwards via a radio transmitting device. The first acquiring unit 101 may receive these physiological parameters and take them as the information on the group of people. Furthermore, the first acquiring unit 101 may receive these physiological parameters in a case where it is authorized by the wearable devices, thereby protecting individual privacies of the users of the wearable devices.

In this embodiment, the physiological parameters of the group of people in the current environment may also be collected and processed by the server, and information on whole conditions of the physiological parameters, such as information on a peak value, a maximum value, a minimum value, and an average value, of distribution of the physiological parameters of the group of people, may be generated and transmitted. Hence, the first acquiring unit 101 may receive the information reflecting the whole conditions of the physiological parameters of the group of people and take it as the information on the group of people. Therefore, what are acquired by the first acquiring unit 101 are not physiological parameters of each of the individuals in the group of people, but information obtained after being processed, thereby protecting privacies of the individuals in the group of people.

Furthermore, in this embodiment, the first acquiring unit 101 may also detect the physiological parameters of the group of people. For example, the first acquiring unit 101 may have a function of infrared detection, etc., and is capable of directly detecting infrared rays, e.g., infrared energy or heat energy, emitted by the group of people in the current environment, detecting such physiological parameters of the group of people as temperatures, etc., and takes them as the information on the group of people. Of course, what are described above are examples only, and this embodiment is not limited thereto, and the first acquiring unit 101 may also acquire the physiological parameters of the group of people in other manners.

In this embodiment, the analyzing unit 102 may compare the information on the group of people acquired by the first acquiring unit 101 with a threshold value, so as to determine whether there exists a hot topic.

In a mode of implementation, when the information on the group of people is the information on the interested topic of the group of people acquired from a social network, the analyzing unit 102 may analyze whether the number of participants, frequencies of updating, and the number of messages that are left, of the interested topic, are greater than predetermined thresholds. If a comparison result is yes, the interested topic is determined as the hot topic, that is, there exists a hot topic; and if a comparison result is no, the interested topic is not the hot topic. Furthermore, in this embodiment, the hot topic determined by the analyzing unit 102 may also be stored and updated regularly.

In this embodiment, the analyzing unit 102 may further analyze the hot topic, so as to obtain information related to the hot topic. For example, when the hot topic is related to a photo, the analyzing unit 102 may analyze taking parameters of the photo, such as a taking angle, an aperture value, and/or a shutter speed; when the hot topic is related to a video, the analyzing unit 102 may analyze taking parameters of the video, such as an image resolution, a frame rate, and/or a video compression manner, etc.; and when the hot topic is related to an audio, the analyzing unit 102 may analyze recording parameters of the audio, such as a bit rate of recording, and/or a sampling rate, etc. Therefore, the data recording apparatus may perform data recording with reference to the above information related to the hot topic.

In another mode of implementation, when the information on the group of people is the physiological parameters of the group of people acquired from the current environment, the analyzing unit 102 may analyze whether an average value, a maximum value, and/or a characteristic quantity of a distribution curve, of these physiological parameters, are greater than predetermined thresholds. If a comparison result is yes, it is determined that there exists a hot topic, that is, there may exist an event attracting interests of surrounding people in the current environment; and if a comparison result is no, it is determined that there exists no hot topic.

In this embodiment, the recording unit 103 may perform the recording action when an analysis result of the analyzing unit 102 is that there exists a hot topic. For example, the recording action may be taking photos, taking videos, and/or recording, etc.

Furthermore, the recording unit 103 may store the recorded data and the hot topic determined or stored by the analyzing unit 102 in an associated manner. For example, in a case where the analyzing unit 102 determines that a topic related to a photo A is a hot topic and the recording unit 103 takes a photo A′ based on the analysis result, the photo A and the photo A′ are stored in an associated manner, thereby associating the recorded data with the hot topic.

In this embodiment, as shown in FIG. 1, the data recording apparatus 100 may further include a second acquiring unit 104 and a first judging unit 105.

The second acquiring unit 104 is configured to acquire an interested point of a user of the data recording apparatus 100, e.g., an interesting point, point of interest or something of interest of or to the user. The first judging unit 105 is configured to judge whether the interested point of the user is related to the hot topic when an analysis result of the analyzing unit 102 is that there exists a hot topic; and the recording unit 103 performs the recording action when it is judged by the first judging unit 105 that the interested point of the user is related to the hot topic.

In this embodiment, the second acquiring unit 104 may acquire the interested point of the user according to a habit of the user of the data recording apparatus at the Internet. For example, the second acquiring unit 104 may detect such information as a topic interested by the user, a group in which the user joins, in the social network, and a keyword used by the user in daily search, etc., and perform analysis, so as to acquire the interested point of the user. For example, the interested topic may be indexed by a keyword, a picture, or a digit, etc.

Furthermore, in this embodiment, a server may detect the habit of the user and perform analysis, so as to obtain the interested point of the user, and the second acquiring unit 104 may acquire the interested point of the user directly from the server. It should be noted that a manner of acquiring the interested point of the user by the second acquiring unit 104 is not limited thereto, and other manners may also be used.

Furthermore, in this embodiment, the interested point of the user may be updated, added, and/or deleted, regularly, etc.

In this embodiment, the first judging unit 105 may compare a similarity between the interested point of the user and the hot topic and a predetermined threshold value. When the similarity is greater than the predetermined threshold value, it is judged that the interested point of the user is related to the hot topic; otherwise, it is judged that they are related. And the recording unit 103 performs the recording action when it is judged by the first judging unit 105 that the interested point of the user is related to the hot topic; otherwise, it does not perform the recording action, thereby enabling the recorded data update to reflect the interested point of the user.

In this embodiment, as shown in FIG. 1, the data recording apparatus 100 may further include a third acquiring unit 106 and a second judging unit 107.

The third acquiring unit 106 is configured to acquire information on an environment where the data recording apparatus 100 is located, and the second judging unit 107 is configured to judge whether the information on the environment is related to the hot topic when an analysis result of the analyzing unit 102 is that there exists a hot topic. The recording unit performs the recording action when it is judged by the second judging unit 107 that the information on the environment is related to the hot topic.

In this embodiment, the information on the environment acquired by the third acquiring unit 106 may be an image signal of a surrounding environment obtained via an image sensor, a voice signal of a surrounding environment obtained via a microphone, and/or a position signal obtained via a global positioning system (GPS), etc. Of course, what are described above are examples only, and the information on the environment acquired by the third acquiring unit 106 may also be other information.

In this embodiment, the second judging unit 107 may compare a similarity between the information on the environment and the hot topic and a predetermined threshold value. When the similarity is greater than the predetermined threshold value, it is judged that the information on the environment is related to the hot topic; otherwise, it is judged that they are not related. And the recording unit 103 performs the recording action when it is judged by the second judging unit 107 that the information on the environment is related to the hot topic; otherwise, it does not perform the recording action, thereby enabling the data recording apparatus to record data of the surrounding environment related to the hot topic.

In this embodiment, as shown in FIG. 1, the data recording apparatus 100 may further include a switch unit 108. The switch unit 108 may make the data recording apparatus 100 to operate in different modes. For example, in a first mode, the recording unit 103 performs the recording action when an analysis result of the analyzing unit 102 is that there exists a hot topic; in a second mode, the recording unit 103 performs the recording action when an analysis result of the analyzing unit 102 is that there exists a hot topic and it is judged by the first judging unit 105 that the interested point of the user is related to the hot topic; in a third mode, the recording unit 103 performs the recording action when an analysis result of the analyzing unit 102 is that there exists a hot topic and it is judged by the second judging unit 107 that the information on the surrounding environment is related to the hot topic; and in a fourth mode, the recording unit 103 performs the recording action when an analysis result of the analyzing unit 102 is that there exists a hot topic, it is judged by the first judging unit 105 that the interested point of the user is related to the hot topic and it is judged by the second judging unit 107 that the information on the surrounding environment is related to the hot topic. Of course, the above four modes are examples only, and the data recording apparatus may operate in other modes.

According to Embodiment 1 of this application, the data recording apparatus may perform the recording action in the case where there exists a hot topic in the group of people, thereby obtaining video and audio data attracting interests of users more easily. Furthermore, the recording action is performed when the interested point of the user of the data recording apparatus is related to the hot topic, thereby further reflecting the interested point of the user by the recorded data. And ever further, the recording action is performed when the information on the environment where the data recording apparatus is located is related to the hot topic, thereby being capable of recording data of the surrounding environment related to the hot topic.

Scenarios where the data recording apparatus 100 of Embodiment 1 performs data recording are described below.

### Scenario 1

The recording action is performed when the hot topic is related to the interested point of the user and the information on the environment where it is located.

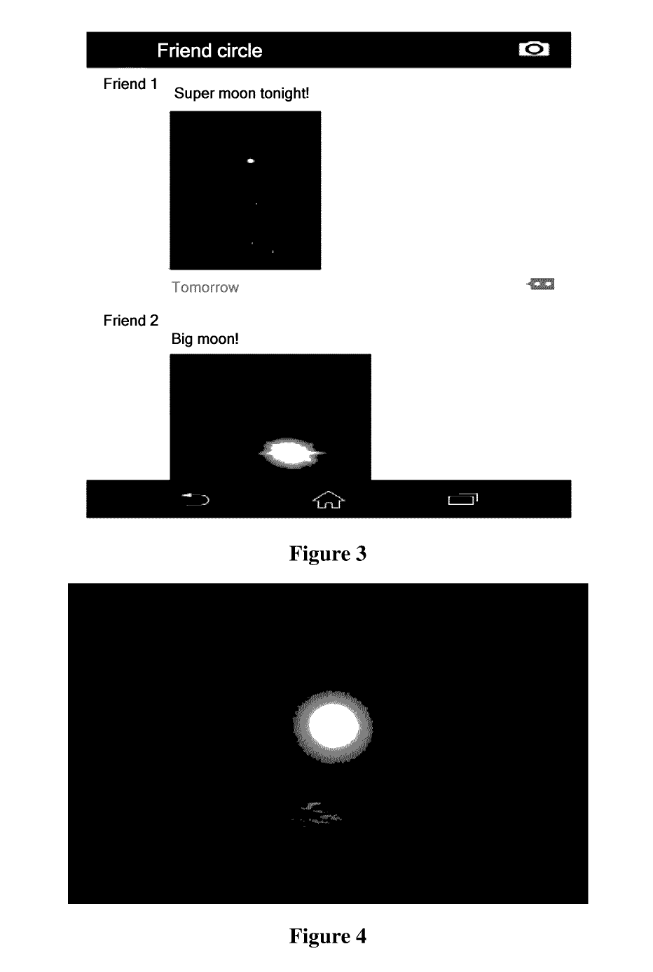

For example, FIG. 3 is a schematic diagram of an interface of a friend circle of a user, and FIG. 4 is a schematic diagram of an image signal of a surrounding environment obtained by an image sensor of the data recording apparatus.

As shown in FIG. 3, information on a current interested topic of the friend circle may be indexed by a keyword “moon” and an image of the moon.

The first acquiring unit 101 acquires the information on the interested topic, and the analyzing unit 102 may determine the interested topic as the current interested topic according to the number of participants of the interested topic.

The interested topic of the user acquired by the second acquiring unit 104 includes also a keyword “moon”, and the first judging unit 105 judges that the interested topic of the user is related to the current hot topic.

The image acquired by the third acquiring unit 106 includes also the moon, as shown in FIG. 4, and the second judging unit 107 performs processing, such as image analysis, and image identification, etc., to the image in FIG. 4, and judges that an identification result is related to the current hot topic.

In a case where both judgment results of the first judging unit 105 and the second judging unit 107 are “being related”, the recording unit 103 records an image signal acquired by an image sensor.

### Scenario 2

The recording action is performed when the hot topic is related to the information on the environment.

For example, if a past hot topic is related to a location of a certain scenic point, a building, or an object, etc., the hot topic may be indexed by GPS coordinates of the location and stored; furthermore, taking parameters, such as a taking angle, an aperture value, and/or a shutter speed, of a photo related to the hot topic, may further be stored.

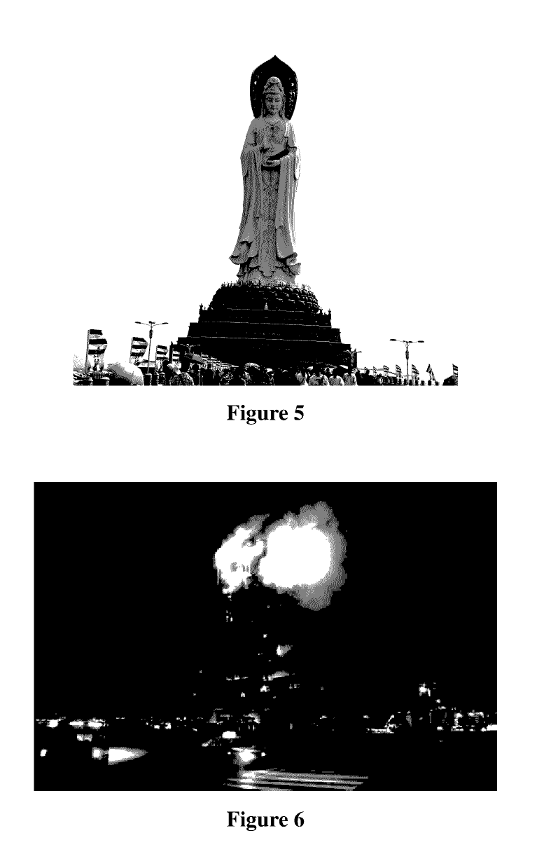

The second judging unit 107 compares the current GPS coordinates acquired by the third acquiring unit 106 and said indexed GPS coordinates. When a distance between them is less than a predetermined threshold value (that is, the distance could be regarded as a parameter that expresses whether they are related), it is judged that they are related, which makes the recording unit 103 to record surrounding image data, which are, as shown in FIG. 5, image data recorded by the recording unit 103.

Furthermore, the recording unit 103 may set current taking parameters with reference to the taking parameters of the photo related to the hot topic, thereby enabling the current taking parameters to be optimized, and facilitating acquisition of a good taking result.

Even further, comments, and/or posted contents, related to the hot topic, may be stored together with the recorded image data.

### Scenario 3

The recording action is performed according to a hot topic of a neighboring group of people and an interested point of a user.

For example, the user meets (encounters) a sudden event occasionally, but does not know the details. At this moment, the data recording apparatus 100 acquires that an interested topic of the neighboring group of people in the social network is “a building is on fire”, and the participants of the interested topic exceeds a threshold value, hence, the analyzing unit 102 determines that there exists a hot topic. The first judging unit 105 judges that the hot topic is related to the interested point of the user, which makes the recording unit 103 to record surrounding image data, which are, as shown in FIG. 6, image data recorded by the recording unit 103.

### Scenario 4

The recording action is performed according to the hot topic and the information on the surrounding environment, and the recorded data and the hot topic are stored in an associated manner.

For example, a match, a vocal concert and a vehicle exhibition held at an exhibition center two weeks ago became hot topics of the time, and pictures regarding the hot topics shared in the friend circle of the user and the GPS coordinates of the exhibition center are stored by the data recording apparatus 100. The shared pictures may be, for example, 702A, 702B, and 702C, etc., which are photos of the match, the vocal concert and the vehicle exhibition, respectively.

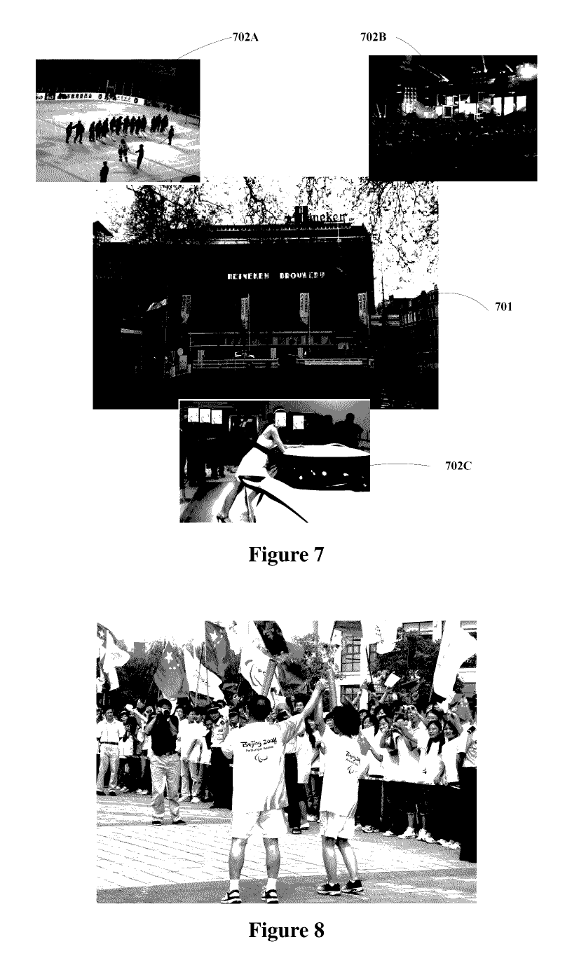

When the user currently passes by the exhibition center, the second judging unit 107 compares the current GPS coordinates acquired by the third acquiring unit 106 and said stored GPS coordinates. When a distance between them is less than a predetermined threshold value, it is judged that they are related, which makes the recording unit 103 to record surrounding image data. For example, the recorded image data are 701, that is, pictures taken outside of the exhibition center; and as shown in FIG. 7, the posted contents in the social network related to the hot topics may be stored together with the recorded image data 701. For example, the photos 702A, 702B, and 702C are stored together with the image data 701.

### Scenario 5

The physiological parameters of the group of people are acquired according to the current environment and are taken as the information on a group of people, and whether the recording action is performed according the information on a group of people.

For example, the user passes by a site of torch relay ceremony of the Olympic Games, but does not know the details. The first acquiring unit 101 receives information on physiological parameters, such as blood pressure values, of wearers transmitted by wearable devices, such as a smart band, of surrounding and watching people; and the analyzing unit 102 analyzes that an average value of the blood pressure values is greater than a threshold value, showing that the surrounding and watching people are excited, and a relatively important event may occur. Therefore, the recording unit 103 may be made to record surrounding image data, which are, as shown in FIG. 8, image data recorded by the recording unit 103.

The above five scenarios are examples only, and embodiments of this application are not limited thereto. In using the data recording apparatus, users may meet more scenarios, which are not enumerated herein any further.

### Embodiment 2

Embodiment 2 of this application provides electronic equipment, including the data recording apparatus described in Embodiment 1. In this application, the electronic equipment may not only be a lifelog camera, but also may be other portable electronic equipment, such as a mobile phone, a tablet personal computer, a gaming device, a digital camera, or a medium player, etc.

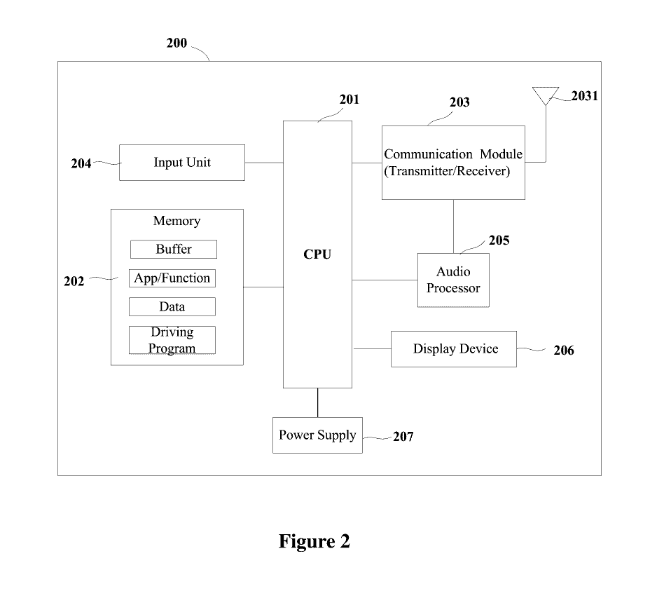

FIG. 2 is a block diagram of the structure of the electronic equipment 200 of the embodiment of this application. As shown in FIG. 2, the electronic equipment 200 may include a central processing unit 201 and a memory 202, the memory 202 being coupled to the central processing unit 201. It should be noted that such a figure is exemplary only, and other types of structures may be used to supplement or replace this structure for the realization of telecommunications functions or other functions.

In a mode of implementation, functions of the data recording apparatus may be integrated into the central processing unit 201. For example, the central processing unit 201 may be configured to: acquire information on a group of people; analyze the information on a group of people, so as to determine whether there exists a hot topic; and perform a recording action when it is determined that there exists a hot topic.

The central processing unit 201 may further be configured to: acquire information on an interested topic of a group of people from a social network and take it as the information on a group of people, or acquire physiological parameters of the group of people from a current environment and take it as the information on a group of people.

The central processing unit 201 may further be configured to be that the group of people is all groups of people or a part of groups of people in the social network.

The central processing unit 201 may further be configured to: acquire an interested point of a user of the data recording apparatus; judge whether the interested point of the user is related to the hot topic when it is determined that there exists a hot topic; and perform the recording action when it is judged that the interested point of the user is related to the hot topic.

The central processing unit 201 may further be configured to: acquire information on an environment where the data recording apparatus is located; judge whether the information on the environment is related to the hot topic when it is determined that there exists a hot topic; and perform the recording action when it is judged that the information on the environment is related to the hot topic.

The central processing unit 201 may further be configured to: store the recorded data and the hot topic in an associated manner.

In another mode of implementation, the data recording apparatus and the central processing unit 201 may be configured separately. For example, the data recording apparatus may be configured as a chip connected to the central processing unit 201, with the functions of the data recording apparatus being realized under control of the central processing unit.

As shown in FIG. 2, the electronic equipment 201 may further include a communication module 203, an input unit 204, an audio processing unit 205, a display 206, and a power supply 207. It should be noted that the electronic equipment 200 does not necessarily include all the parts shown in FIG. 2; furthermore, the electronic equipment 200 may include other parts not shown in FIG. 2, and the prior art may be referred to for these parts.

As shown in FIG. 2, the central processing unit 201 is sometimes referred to as a controller or control, and may include a microprocessor or other processor devices and/or logic devices. The central processing unit 201 receives input and controls operations of every components of the electronic equipment 200.

The memory 202 may be, for example, one or more or a buffer memory, a flash memory, a hard drive, a mobile medium, a volatile memory, a nonvolatile memory, other suitable devices, which may store a program executing related information. And the central processing unit 201 may execute the program stored in the memory 202, so as to realize information storage or processing. Functions of other parts are similar to those of the prior art, which shall not be described herein any further. The parts of the electronic equipment 200 may be realized by specific hardware, firmware, software, or any combination thereof, without departing from the scope of the present disclosure.

### Embodiment 3

Embodiment 3 provides a data recording method, corresponding to the data recording apparatus of Embodiment 1.

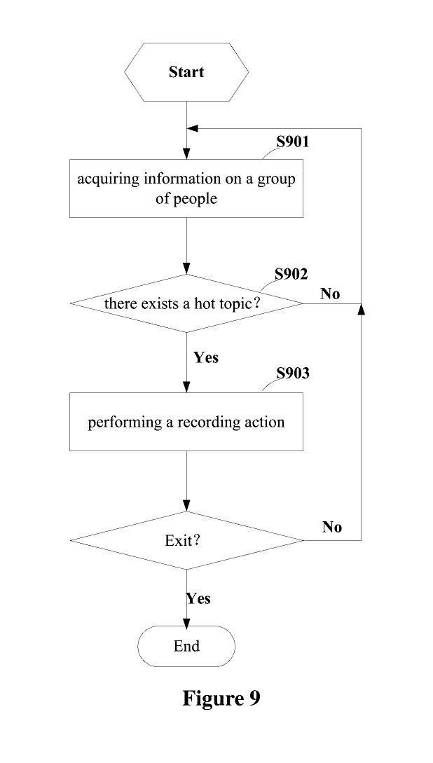

FIG. 9 is a flowchart of a mode of implementation of the method. As shown in FIG. 9, the method includes:

S901: acquiring information on a group of people;

S902: analyzing the acquired information on a group of people, so as to determine whether there exists a hot topic; and

S903: performing a recording action when it is determined that there exists a hot topic.

In this embodiment, in a case where it is judged that the user does not send “exit from the data recording flow”, it is turned back to S901; and in a case where it is judged that the user sends “exit from the data recording flow”, exit from the data recording flow.

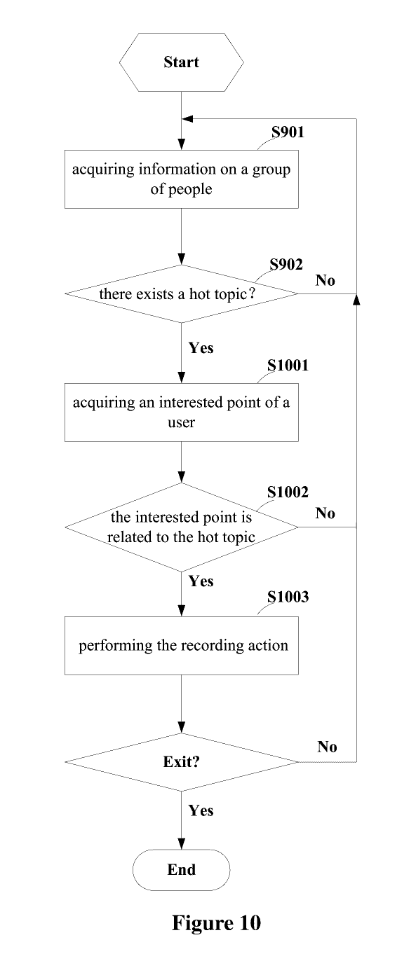

FIG. 10 is a flowchart of another mode of implementation of the method. As shown in FIG. 10, the method includes:

S901: acquiring information on a group of people;

S902: analyzing the acquired information on a group of people, so as to determine whether there exists a hot topic; and

S1001: acquiring an interested point of a user of the data recording apparatus;

S1002: judging whether the interested point of the user is related to the hot topic when it is determined that there exists a hot topic; and

S1003: performing the recording action when it is judged that the interested point of the user is related to the hot topic.

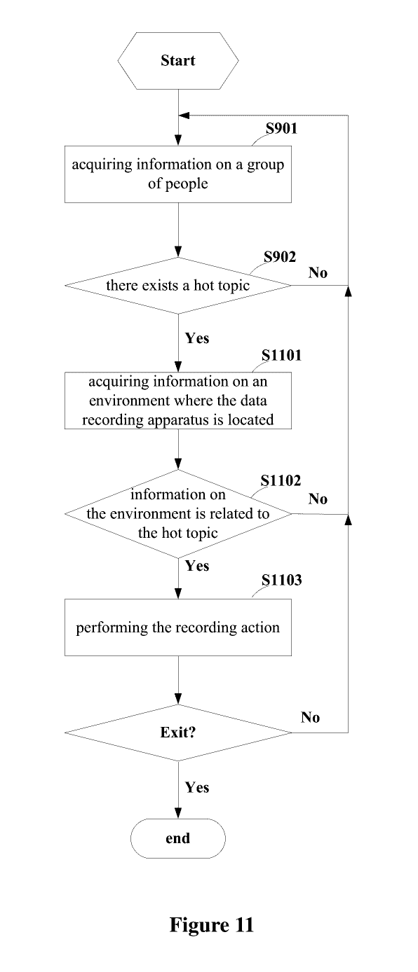

FIG. 11 is a flowchart of still another mode of implementation of the method. As shown in FIG. 11, the method includes:

S901: acquiring information on a group of people;

S902: analyzing the acquired information on a group of people, so as to determine whether there exists a hot topic; and

S1101: acquiring information on an environment where the data recording apparatus is located;

S1102: judging whether the information on the environment is related to the hot topic when it is determined that there exists a hot topic; and

S1103: performing the recording action when it is judged that the information on the environment is related to the hot topic.

Refer to the description of related units in Embodiment 1 for detailed description of the above steps, which shall not be described herein any further.

According to Embodiment 4 of this application, the data recording method may perform the recording action in the case where there exists a hot topic in the group of people, thereby obtaining video and audio data attracting interests of users more easily. Furthermore, the recording action is performed when the interested point of the user of the data recording apparatus is related to the hot topic, thereby further reflecting the interested point of the user by the recorded data. And ever further, the recording action is performed when the information on the environment where the data recording apparatus is located is related to the hot topic, thereby being capable of recording data of the surrounding environment related to the hot topic.

An embodiment of the present disclosure further provides a computer-readable program, wherein when the program is executed in an information processing apparatus or electronic equipment, the program enables the computer to carry out the data recording method as described in Embodiment 4 in the information processing apparatus or electronic equipment.

An embodiment of the present disclosure further provides a storage medium in which a computer-readable program is stored, wherein the computer-readable program enables the computer to carry out the data recording method as described in Embodiment 4 in an information processing apparatus or electronic equipment.

An embodiment of the present disclosure further provides a computer-readable program, wherein when the program is executed in an information processing apparatus or a base station, the program enables the computer to carry out the data recording method as described in Embodiment 4 in the information processing apparatus or the base station.

An embodiment of the present disclosure further provides a storage medium in which a computer-readable program is stored, wherein the computer-readable program enables the computer to carry out the data recording method as described in Embodiment 4 in an information processing apparatus or a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

We claim:

1. A data recording apparatus, comprising:
a first acquiring unit configured to acquire information on a group of people;
an analyzing unit configured to analyze the information on a group of people acquired by the acquiring unit, so as to determine whether there exists a hot topic; and
a recording unit configured to perform a recording action when an analysis result of the analyzing unit is that there exists a hot topic.

2. The data recording apparatus according to claim 1, wherein,
the first acquiring unit acquires information on an interested topic of a group of people from a social network and takes it as the information on a group of people.

3. The data recording apparatus according to claim 2, wherein,
the group of people is all groups of people or a part of groups of people in the social network.

4. The data recording apparatus according to claim 1, wherein,
the first acquiring unit acquires physiological parameters of the group of people from a current environment and takes it as the information on a group of people.

5. The data recording apparatus according to any one of claims 1-4, wherein the data recording apparatus further includes:
a second acquiring unit configured to acquire an interested point of a user of the data recording apparatus; and
a first judging unit configured to judge whether the interested point of the user is related to the hot topic when an analysis result of the analyzing unit is that there exists a hot topic;
and the recording unit performs the recording action when it is judged by the first judging unit that the interested point of the user is related to the popular topic.

6. The data recording apparatus according to claim 1, wherein the data recording apparatus further comprises:
a third acquiring unit configured to acquire information on an environment where the data recording apparatus is located; and
a second judging unit configured to judge whether the information on the environment is related to the hot topic when an analysis result of the analyzing unit is that there exists a hot topic;
and the recording unit performs the recording action when it is judged by the second judging unit that the information on the environment is related to the hot topic.

7. The data recording apparatus according to any one of claims 1-6, wherein,
the recording unit stores recorded data and the hot topic in an associated manner.

8. The data recording apparatus according to any one of claims 1-7, wherein,
the recording unit records picture data, video data and/or audio data.

9. Electronic equipment, having a data recording apparatus, the data recording apparatus is configured to:
acquire information on a group of people;
analyze the information on a group of people, so as to determine whether there exists a hot topic; and
perform a recording action when it is determined that there exists a hot topic.

10. A data recording method, using a data recording apparatus for recording data, the method comprising:
acquiring information on a group of people;
analyzing the acquired information on a group of people, so as to determine whether there exists a hot topic; and
performing a recording action when it is determined that there exists a hot topic.

11. The data recording method according to claim 10, wherein,
information on an interested topic of a group of people is acquired from a social network and is taken as the information on a group of people.

12. The data recording method according to claim 11, wherein,
the group of people is all groups of people or a part of groups of people in the social network.

13. The data recording method according to claim 10, wherein,
physiological parameters of the group of people are acquired from a current environment and is taken as the information on a group of people.

14. The data recording method according to any one of claims 10-13, wherein the data recording method further comprises:
acquiring an interested point of a user of the data recording apparatus; and
judging whether the interested point of the user is related to the hot topic when it is determined that there exists a hot topic; and
performing the recording action when it is judged that the interested point of the user is related to the hot topic.

15. The data recording method according to claim 10, wherein the data recording method further comprises:
acquiring information on an environment where the data recording apparatus is located;
judging whether the information on the environment is related to the hot topic when it is determined that there exists a hot topic; and
performing the recording action when it is judged that the information on the environment is related to the hot topic.

16. The data recording method according to any one of claims 10-15, wherein,
recorded data and the hot topic are stored in an associated manner.

17. The data recording method according to any one of claims 10-16, wherein,
the recording unit records picture data, video data and/or audio data.
